(19) United States
(12) Patent Application Publication
(10) Pub. No.: US 2022/0343211 A1
(43) Pub. Date: Oct. 27, 2022

(54) METHOD, ELECTRONIC DEVICE, AND COMPUTER PROGRAM PRODUCT FOR TRAINING MODEL

(71) Applicant: EMC IP Holding Company LLC, Hopkinton, MA (US)

(72) Inventors: Bing Liu, Tianjin (CN); Lingdong Weng, Beijing (CN); Tao Chen, Beijing (CN)

(21) Appl. No.: 17/349,112

(22) Filed: Jun. 16, 2021

(30) Foreign Application Priority Data
Apr. 21, 2021 (CN) 202110431180.9

(51) Int. Cl. G06N 20/00; G06N 7/00

(52) U.S. Cl. CPC G06N 20/00; G06N 7/005

(57) ABSTRACT

Embodiments of the present disclosure relate to a method, an electronic device, and a computer program product for training a model. The method includes: acquiring a test set and a training set for training models, the test set and the training set each including workload data associated with normal storage devices and workload data associated with exceptional storage devices; training a device detection model using the training set, the device detection model being used to classify storage devices as normal storage devices or exceptional storage devices according to a threshold degree, with the threshold degree being within a range; determining a test result by applying the test set to the device detection model; and updating the range of the threshold degree if it is determined that the test result indicates that the performance of the device detection model does not reach a threshold performance. With this method, storage devices can be accurately detected by the trained model.

### TECHNICAL FIELD

Embodiments of the present disclosure relate to the field of data management, and more particularly, to a method, an electronic device, and a computer program product for training a model.

### BACKGROUND

With the development of information technology, more and more data is generated. This increase in data volume poses a great challenge for data management, especially data storage. The detection of exceptional storage devices is a crucial aspect in the field of data storage, which makes it possible to detect an exceptional storage device in time and prevent that exceptional device from affecting the storage system. However, there exist many problems in the process of detecting exceptional devices; for example, the accuracy of detection needs to be improved.

### SUMMARY OF THE INVENTION

Embodiments of the present disclosure provide a method, an electronic device, and a computer program product for training a model.

According to a first aspect of the present disclosure, a method for training a model is provided. The method includes: acquiring a test set and a training set for training models, the test set and the training set each including workload data associated with normal storage devices and workload data associated with exceptional storage devices; training a device detection model using the training set, the device detection model being used to classify storage devices as normal storage devices or exceptional storage devices according to a threshold degree, with the threshold degree being within a range; determining a test result by applying the test set to the device detection model; and updating the range of the threshold degree if it is determined that the test result indicates that the performance of the device detection model does not reach a threshold performance.

According to a second aspect of the present disclosure, a method for processing data is provided. The method includes: acquiring workload data associated with a storage device, the workload data including at least one of a data access mode and data access performance; and determining a detection result for the workload data using a device detection model trained by the method according to the first aspect, the detection result indicating whether the storage device is an exceptional storage device.

According to a third aspect of the present disclosure, an electronic device is provided. The electronic device includes: at least one processor; and a memory coupled to the at least one processor and having instructions stored thereon, wherein the instructions, when executed by the at least one processor, cause the device to perform actions including: acquiring a test set and a training set for training models, the test set and the training set each including workload data associated with normal storage devices and workload data associated with exceptional storage devices; training a device detection model using the training set, the device detection model being used to classify storage devices as normal storage devices or exceptional storage devices according to a threshold degree, with the threshold degree being within a range; determining a test result by applying the test set to the device detection model; and updating the range of the threshold degree if it is determined that the test result indicates that the performance of the device detection model does not reach a threshold performance.

According to a fourth aspect of the present disclosure, an electronic device is provided. The electronic device includes: at least one processor; and a memory coupled to the at least one processor and having instructions stored thereon, wherein the instructions, when executed by the at least one processor, cause the device to perform actions including: acquiring workload data associated with a storage device, the workload data including at least one of a data access mode and data access performance; and determining a detection result for the workload data using a device detection model trained by the method according to the first aspect, the detection result indicating whether the storage device is an exceptional storage device.

According to a fifth aspect of the present disclosure, a computer program product is provided, which is tangibly stored on a non-volatile computer-readable medium and includes machine-executable instructions, wherein the machine-executable instructions, when executed, cause a machine to perform the steps of the method in the first aspect of the present disclosure.

According to a sixth aspect of the present disclosure, a computer program product is provided, which is tangibly stored on a non-volatile computer-readable medium and includes machine-executable instructions, wherein the machine-executable instructions, when executed, cause a machine to perform the steps of the method in the second aspect of the present disclosure.

### BRIEF DESCRIPTION OF THE DRAWINGS

The above and other objectives, features, and advantages of the present disclosure will become more apparent by describing example embodiments of the present disclosure in more detail with reference to the accompanying drawings, and in the example embodiments of the present disclosure, the same reference numerals generally represent the same components.

FIG. 1 illustrates a schematic diagram of an example of data processing environment 100 in which some embodiments of the present disclosure can be implemented;

FIG. 2 illustrates a schematic diagram of an example of model training environment 200 in which some embodiments of the present disclosure can be implemented;

FIG. 3 illustrates a flow chart of example method 300 for training a model according to some embodiments of the present disclosure;

FIG. 4 illustrates a flow chart of example method 400 for processing data according to some embodiments of the present disclosure;

FIG. 5 illustrates a schematic diagram of relationship 500 of a threshold degree to a first probability and a second probability according to some embodiments of the present disclosure; and

FIG. 6 illustrates a schematic block diagram of example device 600 that can be used to implement embodiments of the present disclosure.

The same or corresponding reference numerals in the various drawings represent the same or corresponding portions.

### DETAILED DESCRIPTION

The embodiments of the present disclosure will be described in more detail below with reference to the accompanying drawings. Although some embodiments of the present disclosure are illustrated in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, i.e., “including but not limited to.” The term “based on” should be understood as “based at least in part on.” The term “an embodiment” or “the embodiment” should be construed as “at least one embodiment.” The terms “first,” “second,” and the like may refer to different or the same objects. Other explicit and implicit definitions may also be included below.

In the embodiments of the present disclosure, the term “model” is capable of processing inputs and providing corresponding outputs. A neural network model, for example, typically includes an input layer, an output layer, and one or more hidden layers between the input layer and the output layer. Models used in deep learning applications (also referred to as “deep learning models”) typically include many hidden layers, thereby extending the depth of the network. The layers of the neural network model are sequentially connected so that the output of the previous layer is used as input to the next layer, where the input layer receives the input to the neural network model and the output of the output layer is used as the final output of the neural network model. Each layer of the neural network model includes one or more nodes (also called processing nodes or neurons), each of which processes the input from the previous layer. Herein, the terms “neural network”, “model”, “network”, and “neural network model” can be used interchangeably.

The principles of the present disclosure will be described below with reference to several example embodiments shown in the accompanying drawings. Although preferred embodiments of the present disclosure are shown in the accompanying drawings, it should be understood that these embodiments are described only to enable those skilled in the art to better understand and then implement the present disclosure, and are not intended to impose any limitation to the scope of the present disclosure.

In conventional exceptional storage detection, detection is usually only possible in cases where each storage device in a redundant array of independent risks (RAID) has the same workload mode in the training model or backup. However, since even in the same RAID, the workload modes of the storage devices may be different. In addition, in other storage scenarios, the workload modes of storage devices are often different as well. Therefore, conventional exceptional storage detection methods are often unable to detect exceptional storage devices in various storage scenarios.

In order to solve the above and other potential problems, the present disclosure provides a method for training a model. In this method, a test set and a training set for training models are first acquired, the test set and the training set each including workload data associated with normal storage devices and exceptional storage devices. Then, a device detection model is trained using the training set, wherein the device detection model can be used to classify storage devices as normal storage devices or exceptional storage devices according to a threshold degree, the threshold degree being within a range. Next, a test result is determined by applying the test set to the device detection model. And finally, the performance of the model is tested according to this test result, and if the performance does not reach a threshold performance, the range of the threshold degree is updated. With this method, the model can be trained accurately according to the workload data. Further, the performance of the trained model can be further improved by using the test set to adjust the threshold degree used by the model to determine exceptional devices.

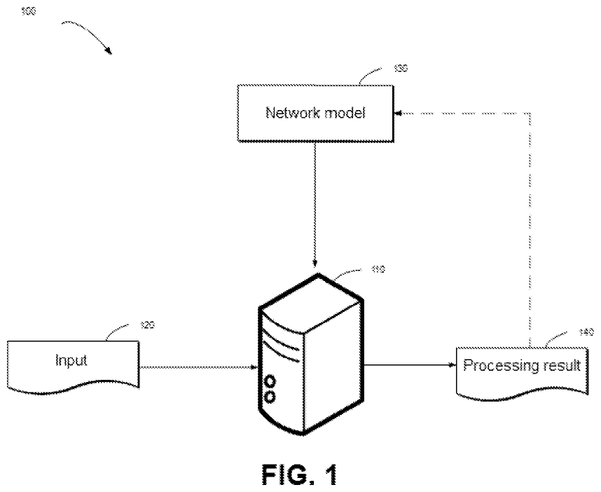

FIG. 1 illustrates a schematic diagram of an example of data processing environment 100 in which some embodiments of the present disclosure can be implemented. As shown in FIG. 1A, data processing environment 100 includes computing device 110. Computing device 110 can be any device with computing power, such as a personal computer, a tablet computer, a wearable device, a cloud server, a mainframe, or a distributed computing system, for example.

Computing device 110 acquires input 120. For example, input 120 can be an image, video, audio, text, and/or multimedia file, etc. Computing device 110 can apply input 120 to network model 130 to generate processing result 140 corresponding to input 120 using network model 130. Network model 130 can be implemented using any suitable network structures, including but not limited to support vector machine (SVM) models, Bayesian models, random forest models, various deep learning/neural network models such as convolutional neural networks (CNN), recurrent neural networks (RNN), deep neural networks (DNN), deep Q networks (DQN), etc. The scope of the present disclosure is not limited in this regard.

Environment 100 may also include a training data acquisition apparatus, a model training apparatus, and a model application apparatus (not shown). In some embodiments, the above multiple apparatuses can be separately implemented in different physical computing devices. Alternatively, at least some of the above multiple apparatuses can be implemented in the same computing device. For example, the training data acquisition apparatus and the model training apparatus can be implemented in the same computing device, while the model application apparatus can be implemented in another computing device.

In some embodiments, during the model training phase, the training data acquisition apparatus can acquire input 120 and provide it to the model. Input 120 can be a test set and network model 130 can be the to-be-trained model. The model training apparatus can train network model 130 based on the input. Processing result 140 can be tailored to different constraints on this model, and computing device 110 can adjust the training parameters (e.g., such as weights and biases) of network model 130 by the different constraints so that the error of the model on the training samples is reduced.

Alternatively, in some embodiments, in the final phase of model training, the input can be the training set and processing result 140 can be a characterization of the performance metric (e.g., accuracy) of trained network model 130.

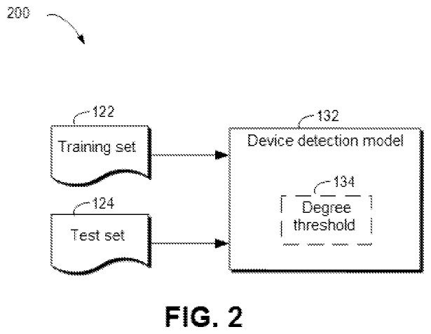

Model training environment 200 will be described in detail below with reference to FIG. 2. Environment 200 may include training set 122 and test set 124 as input 120, and although one training set and test set are illustrated, there may also be multiple training sets and test sets, and the present disclosure is not limited herein.

Computing device 110 can train, using training set 122, the to-be-trained model so as to obtain device detection model 132. In some embodiments, the to-be-trained model can be an isolated forest model in which exceptional samples can be isolated by a smaller number of random feature segmentations compared to normal samples. It is also possible to use any suitable algorithm or model to be trained to obtain device detection model 132, and the present disclosure is not limited herein.

Computing device 110 can test the trained device detection model 132 using test set 122 and further adjust degree threshold 134 of device detection model 132 according to the test result.

Referring back to FIG. 1, the trained network model can be provided to the model application apparatus. The model application apparatus can acquire the trained model and input 120, and determine processing result 140 for input 120. In the model application phase, input 120 can be input data to be processed (e.g., workload data), network model 130 can be a trained model (e.g., device detection model 132), and processing result 140 can be a prediction result (e.g., whether the device is a normal storage device or an exceptional storage device) corresponding to input 120 (e.g., the workload data).

It should be understood that environment 100 shown in FIG. 1 and environment 200 shown in FIG. 2 are only one example in which embodiments of the present disclosure can be implemented and are not intended to limit the scope of the present disclosure. The embodiments of the present disclosure are equally applicable to other systems or architectures.

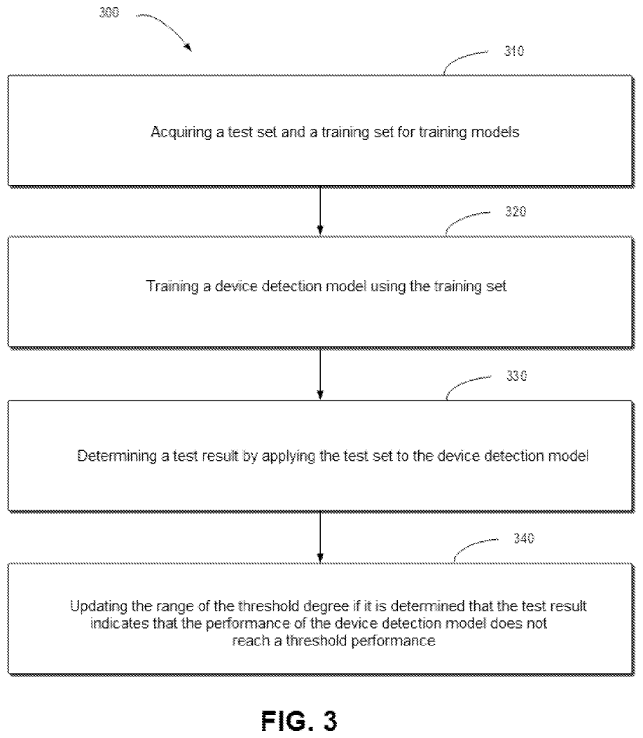

The process of training a model is further described in detail below in conjunction with FIG. 3. FIG. 3 illustrates a flow chart of example method 300 for training a model according to embodiments of the present disclosure. Example method 300 can be implemented by computing device 110 as shown in FIG. 1. For ease of description, example method 300 will be described below with reference to FIGS. 1 and 2.

At block 310 of FIG. 3, computing device 110 acquires test set 122 and training set 124 for training models, test set 122 and training set 124 each including workload data associated with normal storage devices and workload data associated with exceptional storage devices. For example, computing device 110 can acquire workload data of storage devices in different storage scenarios as test set 122 and training set 124.

In some embodiments, the workload data indicates at least one of a data access mode and data access performance. For example, computing device 110 can acquire workload data of storage devices within a predetermined period of time (e.g., within 3 seconds).

For the data access mode, computing device 110 can acquire different data access mode data, for example, it can acquire at least one of the following: the number of read requests, the number of write requests, the average data volume of read requests, the average data volume of write requests, the random access ratio, and the number of non-accesses. For example, computing device 110 can acquire the number of read requests, the number of write requests, the average data volume of read requests, and the average data volume of write requests over a 3-second period. The random access ratio can represent the ratio of the number of random accesses to the total number of accesses. Here, a random access can refer to a situation where the distance between the start address of the current access and the start address of the previous access exceeds a threshold distance (e.g., 2K of storage space). The number of non-accesses refers to the number of operations other than data reads and writes. Since these other operations may also have an impact on the read/write requests in the storage device, it is beneficial to collect this number of non-accesses as training and test data for model training.

For the data access performance, computing device 110 can acquire different access performance data, for example, it can acquire at least one of the following: the average time for requests, the average time for write requests, the maximum time for read requests, the maximum time for write requests, the number of read requests greater than a threshold time, and the number of write requests greater than a threshold time. For example, computing device 110 can acquire the average time for requests, the average time for write requests, the maximum time for read requests, the maximum time for write requests, the number of read requests greater than a threshold time (e.g., 100 ms), and the number of write requests greater than a threshold time (e.g., 100 ms) over a 3-second period. If the read/write request is greater than the threshold time, it indicates that the storage device associated with that read/write request may be exceptional.

Alternatively, in some embodiments, computing device 110 can acquire workload data for scenarios other than storage scenarios (e.g., file cleaning, verification, etc.). By acquiring workload data in various scenarios, i.e., the above access mode data and access performance data, the accuracy and generalization of the model trained using this data can be improved, and thus exceptional storage devices in various different scenarios can be detected.

At block 320 of FIG. 3, computing device 110 trains device detection model 132 using training set 122, device detection model 132 being used to classify storage devices as normal storage devices or exceptional storage devices according to threshold degree 134, with threshold degree 134 being within a range. For example, computing device 110 can train a model according to training set 122 acquired above to obtain device detection model 132.

In some embodiments, computing device 110 can train an isolated forest (iForest) model according to various data acquired as described above to obtain device detection model 132. The isolated forest (iForest) model is a model suitable for exception detection of continuous data. This model defines exceptions as “outliers that are easily isolated”, i.e., exceptional points are points that are sparsely distributed and far from the dense population. A region with sparse distribution indicates that the probability of data occurring in this region is very low, and thus data falling in this region can be considered as exceptional. It can be understood that with the workload data collected in the various scenarios described above and using the characteristics of the isolated forest (iForest) model, trained device detection model 132 can accurately determine exceptional storage devices. The above model is only an example, and any suitable model can also be used as an algorithm to obtain the device detection model. The present disclosure is not limited herein.

Obtained device detection model 132 can classify storage devices as normal storage devices or exceptional storage devices according to threshold degree 134 associated with the device exception degree, and this threshold degree 134 is within a predetermined range. The following will describe how this range is determined to make the performance of device detection model 132 stable (i.e., greater than the threshold performance).

At block 330 of FIG. 3, computing device 110 determines a test result by applying test set 124 to device detection model 132. For example, computing device 110 can apply the test data to device detection model 132 obtained through the above training, so as to determine the test result of device detection model 132 with regard to this test set 124.

In some embodiments, computing device 110 determines, if determining that a first device exception degree determined by device detection model 132 based on a first workload data is greater than threshold degree 134, that a storage device associated with the first workload data is an exceptional storage device; and determines, if a second device exception degree determined by the device detection model based on a second workload data is less than the threshold degree, that the storage device associated with the second workload data is a normal storage device. For example, device detection model 132 can determine the exception degree of the workload data in input test set 124 and compare that exception degree to threshold degree 134.

It can be understood that threshold degree 134 can be dynamic, and high threshold degree 134 may allow more exceptional devices to be detected (a higher true positive rate), but at the same time, it may also cause too many normal devices to be incorrectly detected as exceptional devices (a higher false positive rate); while lower threshold degree 134 may result in a lower false detection rate (lower false positive rate), at the same time, it may also result in a lower correct detection rate (lower true positive rate). The following will describe how to determine the range of this threshold degree to make the performance of the model stable.

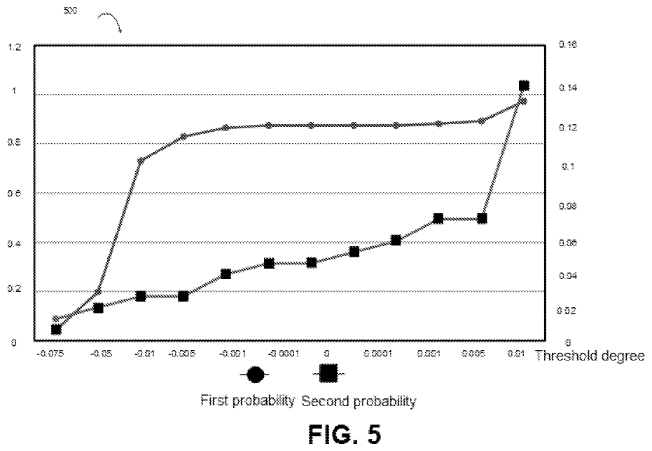

At block 340 of FIG. 3, computing device 110 updates the range of threshold degree 134 if it is determined that the test result indicates that the performance of device detection model 132 does not reach a threshold performance. This step 340 will be described in conjunction with FIG. 5.

In some embodiments, the threshold performance includes a first threshold probability associated with correctly detecting an exceptional storage device and a second threshold probability associated with incorrectly detecting an exceptional storage device. That is, the first threshold probability can indicate the true positive rate expected by device detection model 132, and the second threshold probability can indicate the false positive rate expected by device detection model 132. Computing device 110 can determine a first probability and a second probability associated with the threshold degree according to the test result, the first probability indicating the probability that an exceptional storage device is determined by the model to be an exceptional storage device, and the second probability indicating the probability that a normal storage device is determined by the model to be an exceptional storage device.

For example, test set 124 may include 100 storage devices (that are provided with labels of normal storage devices or exceptional storage devices, wherein the labels indicate that there are 10 exceptional devices and 90 normal devices) and the workload data associated with them. For example, based on a threshold degree 0, device detection model 132 detects 9 of the 10 exceptional devices and incorrectly detects 2 of the 90 normal devices as exceptional devices. Then the first probability (true positive rate) is 0.9, and the second probability (false positive rate) is 0.022. If the first threshold probability is 0.8 and the second threshold probability is 0.1, then this threshold degree 0 satisfies the performance requirements of the model.

Computing device 110 removes from the range a value corresponding to the threshold degree if it is determined that the first probability is less than the first threshold probability or that the second probability is greater than the second threshold probability. For example, as shown in FIG. 5, each threshold degree in the range between −0.075 and 0.01 is associated with a first probability and a second probability. The computing device can remove, from the range between −0.075 and 0.01, the value corresponding to a threshold degree for which the first probability is less than the first threshold probability or the second probability is greater than the second threshold probability. That is, it can be derived from FIG. 5 that the performance of device detection model 132 is stable when threshold degree 134 is in the range between −0.01 and 0.01. Thus, a model with stable performance can be obtained.

Note that the above different values are only examples and different thresholds can be set according to the needs of the model and scenarios, and the present disclosure is not limited herein.

According to embodiments of the present disclosure, with this method, the model can be trained accurately according to the workload data. Further, the performance of the trained model can be further improved by using the test set to adjust the threshold degree used by the model to determine exceptional devices.

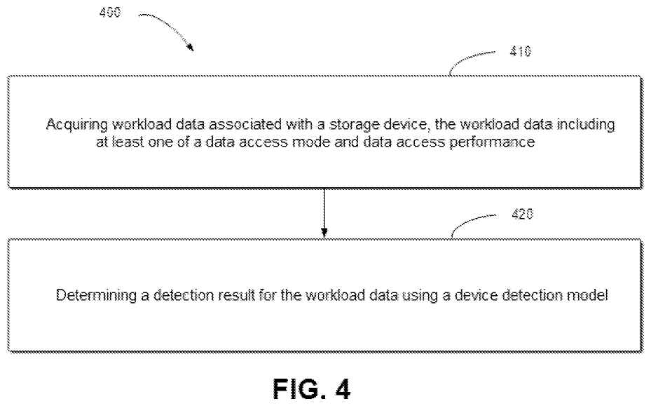

The process of training the model has been described above, and the application of the model will be described below. FIG. 4 illustrates a flow chart of example method 400 for processing data according to some embodiments of the present disclosure.

At block 410 of FIG. 4, computing device 110 acquires workload data associated with a storage device, the workload data including at least one of a data access mode and data access performance. Acquiring the workload data has been described in detail above and will not be repeated here.

At block 420 of FIG. 4, computing device 110 determines a detection result for the workload data using device detection model 132 trained by the method according to the above steps 310-340, the detection result indicating whether the storage device is an exceptional storage device.

In some embodiments, computing device 110 can cause a visual representation of a relationship of threshold degree 134 to a first probability and a second probability to be presented to a user, the first probability indicating the probability that an exceptional storage device is determined by the trained model to be an exceptional storage device, and the second probability indicating the probability that a normal storage device is determined by the trained model to be an exceptional storage device. For example, computing device 110 can present relationship 500 of the threshold degree to the first probability and the second probability to the user through a user interface (e.g., a display). It can be understood that the users are involved in different storage scenarios, and depending on different storage scenarios, some users prefer a higher first probability (true positive rate) and can then set the threshold degree to a higher value (e.g. 0.01), while some other users prefer a lower second probability (false positive rate) and can then set the threshold degree to a lower value (e.g., −0.01). Computing device 110 can then receive input from the user regarding threshold degree 134, and adjust threshold degree 134 based on the user's input. By accepting the user input to dynamically adjust the threshold degree, exceptional storage devices can be accurately detected in different application scenarios.

In one example, if determining that the prediction result indicates that the storage device is an exceptional storage device, computing device 100 causes at least one of the following to be executed: issuing an alert and collecting a log, and performing a data access operation through a normal storage device associated with the exceptional storage device. For example, for the identified exceptional storage device, computing device 110 can enable an alert to be sent to the technical support team, trigger collection of a log associated with the exceptional storage device, or improve data access associated with the exceptional storage device by virtue of the RAID mechanism.

In some embodiments, after computing device 110 detects the exceptional storage device, computing device 110 can utilize other normal storage devices in the same RAID group to achieve the recovery of the desired data if it is determined that there is a read request for this exceptional storage device.

Alternatively, in some other embodiments, after computing device 110 detects the exceptional storage device, computing device 110 can first update the bitmap associated with the exceptional storage device without writing data to this exceptional storage device if it is determined that there is a write request for this exceptional storage device. When determining that the fault in this exceptional storage device is recovered, it can resynchronize the bitmap in the storage device.

By adopting different strategies after detecting the exceptional device, the impact of the exceptional storage device can be minimized, thereby improving the user experience.

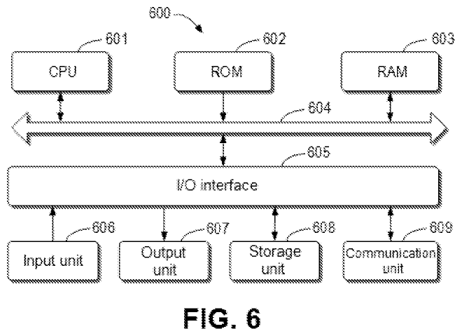

FIG. 6 illustrates a schematic block diagram of example device 600 that can be configured to implement the embodiments of the present disclosure. For example, storage manager 130 as shown in FIG. 1 may be implemented by device 600. As shown in the drawing, device 600 includes central processing unit CPU 601 that may perform various appropriate actions and processing according to computer program instructions stored in read-only memory ROM 602 or computer program instructions loaded from storage unit 608 into random access memory RAM 603. In RAM 603, various programs and data required for operations of device 600 may also be stored. CPU 601, ROM 602, and RAM 603 are connected to each other through bus 604. Input/output (I/O) interface 605 is also connected to bus 604.

Multiple components in device 600 are connected to I/O interface 605, including: input unit 606, such as a keyboard and a mouse; output unit 607, such as various types of displays and speakers; storage unit 608, such as a magnetic disk and an optical disc; and communication unit 609, such as a network card, a modem, and a wireless communication transceiver. Communication unit 609 allows device 600 to exchange information/data with other devices over a computer network such as an Internet and/or various telecommunication networks.

The various processes and processing described above, for example, methods 300 and 400, can be performed by processing unit 601. For example, in some embodiments, methods 300 and 400 may be implemented as a computer software program that is tangibly included in a machine-readable medium such as storage unit 608. In some embodiments, part or all of the computer program may be loaded and/or installed to device 600 via ROM 602 and/or communication unit 609. When the computer program is loaded to RAM 603 and executed by CPU 601, one or more actions of methods 300 and 400 described above may be executed.

The present disclosure may be a method, an apparatus, a system, and/or a computer program product. The computer program product may include a computer-readable storage medium on which computer-readable program instructions for performing various aspects of the present disclosure are loaded.

The computer-readable storage medium may be a tangible device capable of retaining and storing instructions used by an instruction-executing device. The computer-readable storage medium may be, for example, but is not limited to, an electric storage device, a magnetic storage device, an optical storage device, an electromagnetic storage device, a semiconductor storage device, or any suitable combination of the foregoing. More specific examples, as a non-exhaustive list, of computer-readable storage media include: a portable computer disk, a hard disk, a random access memory RAM, a read-only memory ROM, an erasable programmable read-only memory EPROM or a flash memory, a static random access memory SRAM, a portable compact disc read-only memory CD-ROM, a digital versatile disc DVD, a memory stick, a floppy disk, a mechanical encoding device, for example, a punch card or a raised structure in a groove with instructions stored thereon, and any suitable combination of the foregoing. Computer-readable storage media used herein are not to be interpreted as transient signals per se, such as radio waves or other freely propagating electromagnetic waves, electromagnetic waves propagating through waveguides or other transmission media (for example, light pulses through fiber optic cables), or electrical signal transmitted via electrical wires.

The computer-readable program instructions described herein can be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. The network adapter card or network interface in each computing/processing device receives computer-readable program instructions from the network and forwards the computer-readable program instructions for storage in a computer-readable storage medium in each computing/processing device.

The computer program instructions for performing the operations of the present disclosure may be assembly instructions, Instruction Set Architecture ISA instructions, machine instructions, machine-related instructions, microcode, firmware instructions, status setting data, or source code or object code written in any combination of one or more programming languages, including object-oriented programming languages, such as Smalltalk and C++, as well as conventional procedural programming languages, such as C language or similar programming languages. The computer-readable program instructions may be executed entirely on a user computer, partly on a user computer, as a standalone software package, partly on a user computer and partly on a remote computer, or entirely on a remote computer or a server. When a remote computer is involved, the remote computer may be connected to a user computer through any kind of network, including a local area network (LAN) or a wide area network (WAN), or may be connected to an external computer (e.g., connected over the Internet using an Internet service provider). In some embodiments, an electronic circuit, such as a programmable logic circuit, a field programmable gate array (FPGA), or a programmable logic array (PLA), is customized by utilizing state information of the computer-readable program instructions. The electronic circuit may execute the computer-readable program instructions so as to implement various aspects of the present disclosure.

Various aspects of the present disclosure are described here with reference to flow charts and/or block diagrams of the method, the apparatus/system, and the computer program product according to the embodiments of the present disclosure. It should be understood that each block in the flow charts and/or block diagrams as well as a combination of blocks in the flow charts and/or block diagrams may be implemented by using the computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed basically in parallel, and sometimes they may also be executed in an inverse order, which depends on involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Various embodiments of the present disclosure have been described above. The foregoing description is illustrative rather than exhaustive, and is not limited to the disclosed embodiments. Numerous modifications and alterations are apparent to those of ordinary skill in the art without departing from the scope and spirit of the illustrated embodiments. The selection of terms as used herein is intended to best explain the principles and practical applications of the various embodiments or technical improvements to technologies on the market, or to enable other persons of ordinary skill in the art to understand the embodiments disclosed here.

1. A method for training a model, comprising:
acquiring a test set and a training set for training models, the test set and the training set each comprising workload data associated with normal storage devices and workload data associated with exceptional storage devices;
training a device detection model using the training set, the device detection model being used to classify storage devices as normal storage devices or exceptional storage devices according to a threshold degree, with the threshold degree being within a range;
determining a test result by applying the test set to the device detection model; and
updating the range of the threshold degree if it is determined that the test result indicates that a performance of the device detection model does not reach a threshold performance.

2. The method according to claim 1, wherein the threshold performance comprises a first threshold probability associated with correctly detecting an exceptional storage device and a second threshold probability associated with incorrectly detecting an exceptional storage device, and wherein updating the range of the threshold degree comprises:
determining a first probability and a second probability associated with the threshold degree based on the test result, the first probability indicating a probability that an exceptional storage device is determined by the device detection model to be an exceptional storage device, and the second probability indicating the probability that a normal storage device is determined by the device detection model to be an exceptional storage device; and
removing from the range a value corresponding to the threshold degree if it is determined that the first probability is less than the first threshold probability or that the second probability is greater than the second threshold probability.

3. The method according to claim 1, wherein determining the test result comprises:
determining, if a first device exception degree determined by the device detection model based on a first workload data is greater than the threshold degree, that a storage device associated with the first workload data is an exceptional storage device; and
determining, if a second device exception degree determined by the device detection model based on a second workload data is less than the threshold degree, that the storage device associated with the second workload data is a normal storage device.

4. The method according to claim 1, wherein the workload data indicates at least one of a data access mode and data access performance.

5. The method according to claim 4, wherein the data access mode comprises at least one of: a number of read requests, a number of write requests, an average data volume of read requests, an average data volume of write requests, a random access ratio, or a number of non-accesses.

6. The method according to claim 4, wherein the data access performance comprises at least one of: an average time for requests, an average time for write requests, a maximum time for read requests, a maximum time for write requests, a number of read requests greater than a threshold time, or a number of write requests greater than a threshold time.

7. A method for processing data, comprising:
acquiring workload data associated with a storage device, the workload data comprising at least one of a data access mode and data access performance; and
determining a detection result for the workload data using a device detection model, the detection result indicating whether the storage device is an exceptional storage device, wherein the device detecting model is trained by:
acquiring a test set and a training set for training models, the test set and the training set each comprising workload data associated with normal storage devices and workload data associated with exceptional storage devices,
training a device detection model using the training set, the device detection model being used to classify storage devices as normal storage devices or exceptional storage devices according to a threshold degree, with the threshold degree being within a range,
determining a test result by applying the test set to the device detection model, and
updating the range of the threshold degree if it is determined that the test result indicates that a performance of the device detection model does not reach a threshold performance

8. The method according to claim 7, further comprising:
causing a visual representation of a relationship of the threshold degree to a first probability and a second probability to be presented to a user, the first probability indicating the probability that an exceptional storage device is determined by the device detecting model to be an exceptional storage device, and the second probability indicating a probability that a normal storage device is determined by the device detecting model to be an exceptional storage device;
receiving an input from the user regarding the threshold degree, and
adjusting the threshold degree based on the input from the user.

9. The method according to claim 7, further comprising:
if a prediction result indicates that the storage device is an exceptional storage device, causing at least one of the following to be executed:
issuing an alert and collecting a log, and
performing a data access operation through a normal storage device associated with the exceptional storage device.

10. An electronic device, comprising:
at least one processor; and
a memory coupled to the at least one processor and having instructions stored thereon, wherein the instructions, when executed by the at least one processor, cause the device to perform actions comprising:
acquiring a test set and a training set for training models, the test set and the training set each comprising workload data associated with normal storage devices and workload data associated with exceptional storage devices;
training a device detection model using the training set, the device detection model being used to classify storage devices as normal storage devices or exceptional storage devices according to a threshold degree, with the threshold degree being within a range;
determining a test result by applying the test set to the device detection model; and
updating the range of the threshold degree if it is determined that the test result indicates that a performance of the device detection model does not reach a threshold performance.

11. The electronic device according to claim 10, wherein the threshold performance comprises a first threshold probability associated with correctly detecting an exceptional storage device and a second threshold probability associated with incorrectly detecting an exceptional storage device, and wherein updating the range of the threshold degree comprises:
determining a first probability and a second probability associated with the threshold degree based on the test result, the first probability indicating a probability that an exceptional storage device is determined by the model to be an exceptional storage device, and the second probability indicating a probability that a normal storage device is determined by the model to be an exceptional storage device; and
removing from the range a value corresponding to the threshold degree if it is determined that the first probability is less than the first threshold probability or that the second probability is greater than the second threshold probability.

12. The electronic device according to claim 10, wherein determining the test result comprises:
determining, if a first device exception degree determined by the device detection model based on a first workload data is greater than the threshold degree, that a storage device associated with the first workload data is an exceptional storage device; and
determining, if a second device exception degree determined by the device detection model based on a second workload data is less than the threshold degree, that the storage device associated with the second workload data is a normal storage device.

13. The electronic device according to claim 10, wherein the workload data indicates at least one of a data access mode and data access performance.

14. The electronic device according to claim 13, wherein the data access mode comprises at least one of: a number of read requests, a number of write requests, an average data volume of read requests, an average data volume of write requests, a random access ratio, or a number of non-accesses.

15. The electronic device according to claim 13, wherein the data access performance comprises at least one of: an average time for requests, an average time for write requests, a maximum time for read requests, a maximum time for write requests, a number of read requests greater than a threshold time, or a number of write requests greater than a threshold time.

16.-20. (canceled)

21. The method according to claim 7, wherein the threshold performance comprises a first threshold probability associated with correctly detecting an exceptional storage device and a second threshold probability associated with incorrectly detecting an exceptional storage device, and wherein updating the range of the threshold degree comprises:
determining a first probability and a second probability associated with the threshold degree based on the test result, the first probability indicating a probability that an exceptional storage device is determined by the device detection model to be an exceptional storage device, and the second probability indicating the probability that a normal storage device is determined by the device detection model to be an exceptional storage device; and
removing from the range a value corresponding to the threshold degree if it is determined that the first probability is less than the first threshold probability or that the second probability is greater than the second threshold probability.

22. The method according to claim 7, wherein determining the test result comprises:
determining, if a first device exception degree determined by the device detection model based on a first workload data is greater than the threshold degree, that a storage device associated with the first workload data is an exceptional storage device; and
determining, if a second device exception degree determined by the device detection model based on a second workload data is less than the threshold degree, that the storage device associated with the second workload data is a normal storage device.

23. The method according to claim 7, wherein the workload data indicates at least one of a data access mode and data access performance.

24. The method according to claim 23, wherein the data access mode comprises at least one of: a number of read requests, a number of write requests, an average data volume of read requests, an average data volume of write requests, a random access ratio, or a number of non-accesses.

25. The method according to claim 23, wherein the data access performance comprises at least one of: an average time for requests, an average time for write requests, a maximum time for read requests, a maximum time for write requests, a number of read requests greater than a threshold time, or a number of write requests greater than a threshold time.
